(19) United States
(12) Patent Application Publication
(10) Pub. No.: US 2004/0011645 A1
(43) Pub. Date: Jan. 22, 2004

(54) Oxygen sensor and process of use

(76) Inventors: Richard F. Beckmeyer, Davisburg, MI (US); Kathryn M. McCauley, Durand, MI (US); David K. Chen, Rochester Hills, MI (US); Harold Adams, Flushing, MI (US); Eric P. Clyde, Bay City, MI (US)

Correspondence Address: VINCENT A. CICHOSZ, DELPHI TECHNOLOGIES, INC., Legal Staff, Mail Code: 480-410-202, P.O. Box 5052, Troy, MI, 48007-5052, US

(21) Appl. No.: 10/200,400

(22) Filed: Jul. 22, 2002

(51) Int. Cl. G01N 27/407

(52) U.S. Cl. 204/424; 204/428

(57) ABSTRACT

A gas sensor comprises a first electrode and a second electrode; and an electrolyte disposed between the first electrode and the second electrode. The electrolyte is shaped into a cylinder having an axial open end portion, an axial middle portion, and an axial closed end portion. The axial closed end portion has a uniform wall thickness equal to or less than about 1.5 millimeters. A radial transition in an interior region of the electrolyte between the middle and the closed end portions forms a shoulder. Processes for sensing exhaust gas generally includes disposing the gas sensor in an exhaust stream, contacting the closed end portion of the sensor with exhaust gas, and creating an electromotive force. The sensor activates quickly due to the close proximity to a rod heater and the low thermal mass resulting from the small inner diameter and thin wall section of the closed end portion.

### BACKGROUND

The present disclosure relates to exhaust gas sensors for analyzing gases in an exhaust gas emitted from an engine of a vehicle, and more particularly, to an oxygen sensor.

Gas sensors are used in a variety of applications that require qualitative and quantitative analysis of gases. In automotive applications, the direct relationship between oxygen concentration in the exhaust gas and air-to-fuel ratio of the fuel mixture supplied to the engine allows the gas sensor to provide oxygen concentration measurements for determination of optimum combustion conditions, maximization of fuel economy, and management of exhaust emissions.

A conventional stoichiometric gas sensor typically consists of an ionically conductive solid electrolyte material, a porous electrode on the sensor's exterior exposed to the exhaust gases with a porous protective overcoat, and a porous electrode on the sensor's interior surface exposed to a known oxygen partial pressure. Sensors typically used in automotive applications use a yttria stabilized zirconia based electrochemical galvanic cell with porous platinum electrodes, operating in potentiometric mode, to detect the relative amounts of oxygen present in an automobile engine's exhaust. When opposite surfaces of this galvanic cell are exposed to different oxygen partial pressures, an electromotive force is developed between the electrodes on the opposite surfaces of the zirconia wall, according to the Nernst equation:

$$E = ( \frac{- RT}{4 F} ) ln ( \frac{{P}_{{O}_{2}}^{ref}}{{P}_{{O}_{2}}} )$$

where:

$$\begin{matrix}E = electromotive force \\ R = universal gas constant \\ F = Faraday constant \\ T = absolute temperature of the gas \\ {P}_{{O}_{2}}^{ref} = oxygen partial pressure of the reference gas \\ {P}_{{O}_{2}} = oxygen partial pressure of the exhaust gas\end{matrix}$$

Due to the large difference in oxygen partial pressure between fuel-rich and fuel-lean exhaust conditions, the electromotive force changes sharply at the stoichiometric point, giving rise to the characteristic switching behavior of these sensors. Consequently, these potentiometric gas sensors indicate qualitatively whether the engine is operating fuel-rich or fuel-lean, without quantifying the actual air-to-fuel ratio of the exhaust mixture.

The majority of hydrocarbon and carbon monoxide emissions from gasoline engines are produced within the first few minutes of operation. For these reasons, it is desirable to produce an oxygen sensor that begins to operate as quickly as possible to allow faster stoichiometric control of the air-fuel ratio and reduce hydrocarbon and carbon monoxide emissions. Oxygen sensors are usually activated at about 350° C. To assure accurate and reliable operation of the oxygen sensor even when the temperature of the exhaust gas is relatively low, a suitable heater or heating means is generally provided to heat at least the oxygen detecting portion of the sensing element on which the electrodes are disposed, so that the oxygen detecting portion is maintained at a desired elevated operating temperature. For example, in a tubular shaped sensor, an electric resistance rod heater may be disposed within a bore formed in the tube.

Even with the use of heaters, improving the time to activation for oxygen sensors is of commercial and environmental significance. For example, any improvement in reducing the time to activation provides immediate benefits by reducing hydrocarbon and carbon monoxide emissions. Factors for achieving improved activation times include, among others, the proximity of the heater to the sensor element and the mass of the ceramic element. The more intimate the contact between the heater and the ceramic body (electrolyte) of the sensor, as well as providing less mass in the ceramic body results in faster activation of the oxygen sensor.

### SUMMARY

Disclosed herein is a gas sensor that reduces the time for activation. The gas sensor comprises a first electrode and a second electrode; and an electrolyte disposed between the first electrode and the second electrode, an electrolyte disposed between the first electrode and the second electrode, wherein the electrolyte is cylindrically shaped with an axial open end portion and an axial closed end portion, and wherein the closed end portion has a uniform wall thickness equal to or less than about 1.5 millimeters.

In another embodiment, the gas sensor comprises a first electrode and a second electrode; and an electrolyte disposed between the first electrode and the second electrode, wherein the electrolyte is cylindrically shaped with an axial open end portion having an inner diameter D1, an axial middle portion having an inner diameter D2, and an axial closed end portion having an inner diameter D3, wherein D1 is greater than D2 and D2 is greater than D3.

In a process for sensing exhaust gas, the process comprises disposing a gas sensor in an exhaust stream, the gas sensor comprising a sensing electrode, a reference electrode, and an electrolyte disposed between the sensing electrode and the reference electrode, wherein the electrolyte is shaped into a cylinder with an axial open end portion and an axial closed end portion, wherein the axial closed end portion has a uniform wall thickness equal to or less than about 1.5 millimeters of the closed end portion; contacting the closed end portion of the sensor with the exhaust gas; and creating an electromotive force.

The above described and other features will become better understood from the detailed description that is described in conjunction with the accompanying drawings.

### BRIEF DESCRIPTION OF THE DRAWINGS

Referring now to the drawings, which are meant to be exemplary and not limiting:

FIG. 1 is a sectional view of an oxygen sensor, the sensor being shown fixed to an exhaust tube of an engine system;

FIG. 2 is a sectional view of the oxygen sensor of FIG. 1;

FIG. 3 is a sectional view of a prior art oxygen sensor; and

FIG. 4 graphically illustrates the time for activation for oxygen sensors constructed in accordance with the present disclosure compared to prior art oxygen sensors.

### DESCRIPTION OF A PREFERRED EMBODIMENT

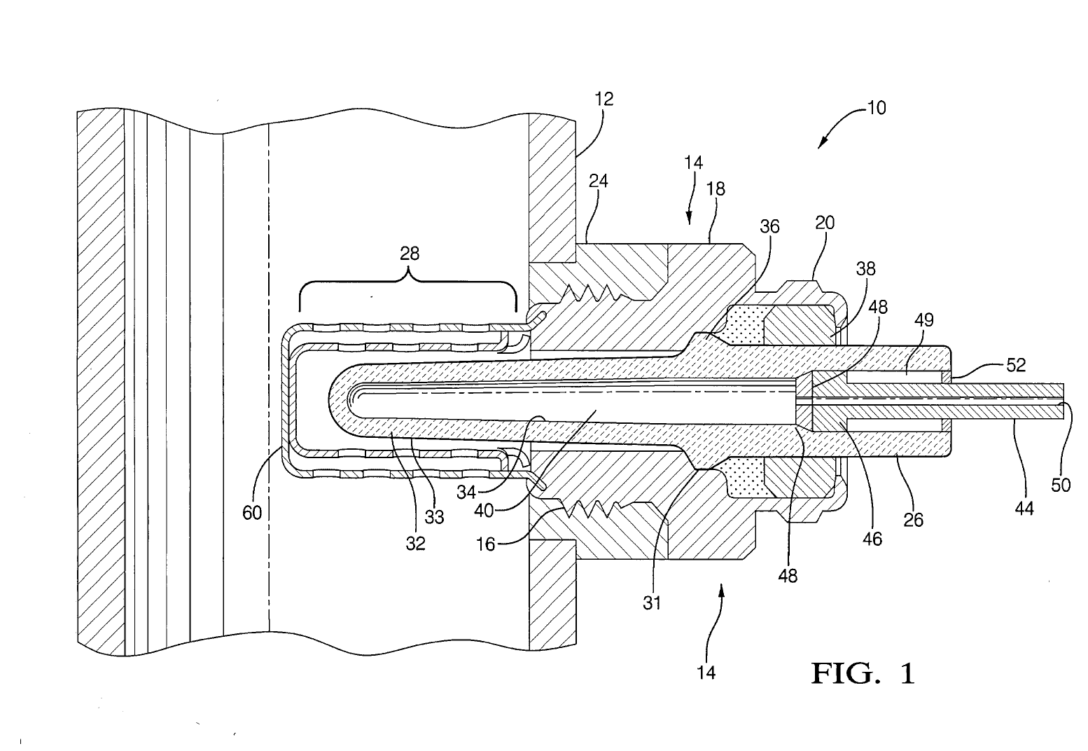

In FIG. 1, there is shown an oxygen sensor generally designated 10 and is shown accompanied with an exhaust tube 12 through which exhaust gases can be issued from an engine, e.g., an internal combustion engine.

The oxygen sensor 10 comprises an outer cylindrical holder, shown generally at 14, having an externally threaded portion 16 terminating in a radial shoulder portion 18 and a relatively thin plate tube portion 20 extending outwardly from the radial end portion 18. The radial shoulder portion 18 is used for facilitating acceptance and seating of the outer cylindrical holder 14 in a threaded bore formed in an annular connector 24, which has been firmly connected to the exhaust tubing 12.

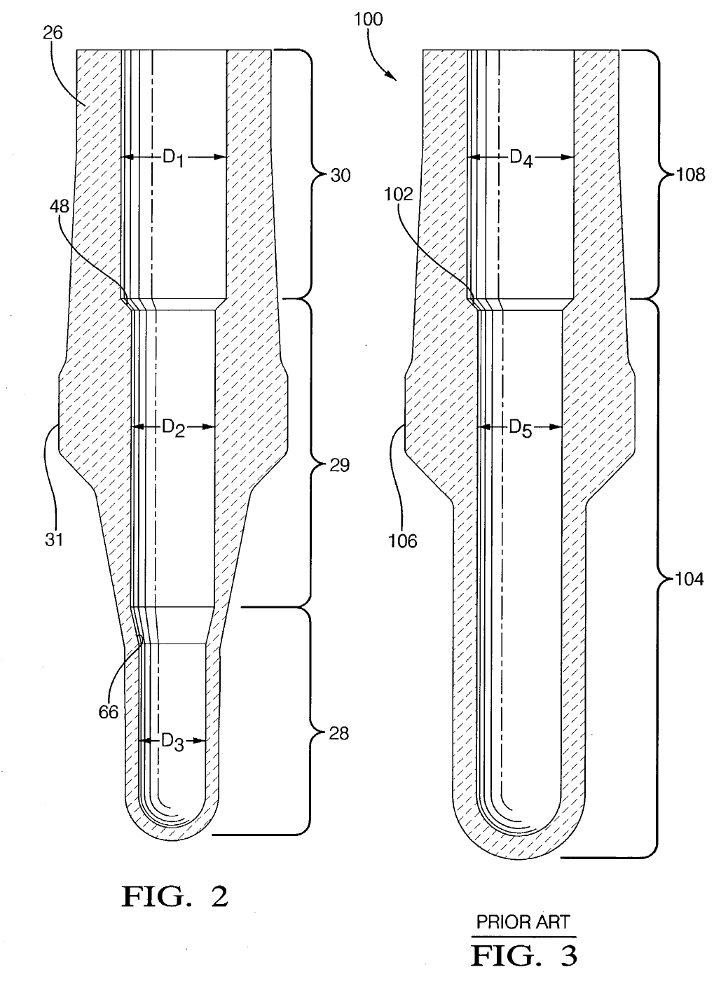

Disposed in the outer cylindrical holder 14 while projecting at its leading portion into the interior of the exhaust tube 12 is a solid state oxygen electrolyte 26, which is formed into a generally cylindrical structure as shown more clearly in FIG. 2 having an axial closed end portion 28, an axial open end portion 30, and having at its axial middle portion 29 a radially outward raised portion 31. As shown, the axial closed end portion 28 is located in or projected into the interior of the exhaust tube 12.

The outer and inner surfaces of the cylindrical electrolyte 26 are covered or coated with first and second electrodes 32, and 34, which are electrically insulated from one another. The first electrode 32 functions as the sensing electrode whereas the second electrode 34 functions as the reference electrode. The electrolyte 26 with the first and second electrodes 32 and 34 respectively, are disposed in the outer cylindrical holder 14 in such a manner that the radially outwardly raised portion 31 thereof is snugly fitted in the enlarged bore 36 formed in the holder 14. Thus, the axial movement of the electrolyte 26 toward the inside of the exhaust tube 12 relative to the holder 14 is prevented. A non-conductive protective coating is disposed onto the first electrode 32 for electrically isolating first electrode 32 from the holder 14. A space 38 defined between the holder 14 and the first electrode 32 and extending from the raised portion 31 to the axial open end portion 30 of the electrolyte 26 is filled or packed with a non-conductive powder such as a talc material.

A connecting rod 44 is preferably secured at its enlarged head portion 46 to the portion of second electrode 34 located on shoulder 48 formed at the inner surface of the electrolyte 26. The connecting rod 44 is formed with an axially extending fluid passageway 50 for providing fluid communication between the interior of the electrolyte 26 and the atmosphere. A heater 40, e.g., a ceramic rod heater, is disposed in the air reference area of the sensor 10 preferably extending from the enlarged head portion 46 to the closed end portion 28. The heater 40 comprises an outer diameter that is about equal to the inner diameter D3 of the closed end portion 28 to provide minimal clearance and maximum heat transfer between the closed end portion 28 and the ceramic rod heater 40. Advantageously, the stepwise progression from axial open end 30 to the axial closed end 28 allows for some curvature of the heater rod, which is normally a characteristic that occurs during fabrication of the heater rod 40. A space 49 defined between the second electrode 34 and the connecting rod 44 and extending from the enlarged head portion 46 through the axial open end portion 30 of the electrolyte 26 can also be filled or packed with an electrically conducting powder, and/or a conductive ring 52 can be tightly disposed in this space. A protective shield 60 is disposed about the lower axial closed end portion 28.

As shown more clearly in FIG. 2, the oxygen sensor generally comprises a cylindrically shaped electrolyte 26 that includes the closed end portion 28, the middle portion 29, and the open end portion 30. A generally radial transition between the middle and open end portions forms shoulder 48 and between the middle and closed end portions forms shoulder 66. Shoulder 66 provides closer proximity of the closed end portion 28 with the heater 40, which is assembled into the finished oxygen sensor. In a preferred embodiment, the length of the closed end portion 28 preferably corresponds with the length of the heater zone on the heater 40. The open end portion 30 has a larger inner diameter D1 than the inner diameter D2 of the middle portion 29, while the middle portion 29 has a larger inner diameter D2 than the inner diameter D3 of the closed end portion 28.

The cylindrically shaped electrolyte 26 includes the radially outwardly raised portion 31 in the axial middle portion 29. From the raised portion 31 of the axial middle portion 29 to the axial closed end portion 28, the wall thickness is shown as tapering to a uniform thickness in the closed end portion 28. The degree of taper is preferably an amount effective to provide minimal clearance between the outer diameter of heater 40 and the inner diameter D3 of the closed end portion 28. Preferably, the uniform wall thickness in the closed end portion 28 is less than or equal to 1.5 millimeters, with less than or equal to about 1 millimeter even more preferred, and with less than 0.5 millimeter most preferred. The wall thickness in the closed end portion 28 represents the thinnest wall section of the cylindrically shaped electrolyte 26. As previously described, the closed end portion 28 is located in or projected into the interior of the exhaust tube 12. The uniform and relatively small wall thickness, smaller inner diameter, and outer diameter in the closed end portion provides uniform exposure to the exhaust gas as well as even heating during use. While not wanting to be bound by theory, it is believed that the uniform and relatively small wall thickness enables the oxygen sensor to attain activation temperatures faster than previously possible. Moreover, a reduced thermal mass resulting from the relatively small wall thickness as well as the reduced clearance between the inner diameter D3 of the oxygen sensor and the heater 40 improves heat transfer and further reduces the time to attain activation temperatures.

In comparison, FIG. 3 illustrates a prior art cylindrically shaped electrolyte 100 for an oxygen sensor. In such a conventional oxygen sensor, it has usually been observed that the cylindrically shaped electrolyte 100 generally comprises an open end portion 102 and a closed end portion 104, wherein an inner diameter D4 of the open end portion 102 is greater than an inner diameter D5 of the closed end portion 104. A generally radial transition between the open end and closed end portions forms shoulder 108. There is no additional shoulder formed in the closed end portion. That is, the inner diameter D5 is constant throughout the length of the closed end portion 104. A radially outward raised portion 106 is disposed in the lower portion 102. Although the thickness of the wall extending from the raised portion 106 to the closed end portion 106 can be substantially uniform, the electrolyte is typically constructed to have a large wall thickness of about 2 to about 3 millimeter (mm) or more. As a result, inner impedance of the electrolyte is undesirably increased. Moreover, because of the large wall thickness of the electrolyte, it takes a relatively long time to warm up the electrolyte and make it active. Consequently, both the sensitivity of the conventional oxygen sensor and the lasting quality of the same are undesirably decreased.

In other prior art gas sensors, the thickness of the wall extending from the raised portion to the closed end portion 106 is tapered. That is, the wall thickness is gradually reduced from the raised portion to the tip of the closed end portion. As a result, the wall thickness is variable along the length of the closed end portion 106 including the portion of the closed end portion that is exposed to the exhaust gas, i.e., the active region. Due to the variability of the wall thickness within the active region, heat transfer and activation time is poor, i.e., during operation a temperature gradient results that will affect the response time. Moreover, as previously discussed, the electrolyte is typically constructed to have a large wall thickness of about 2 to about 3 mm or more, thereby further reducing sensitivity.

In an actual working example, the cylindrically shaped electrolyte 26 of the oxygen sensor 10 had an axial length of about 48.8 millimeters (mm), wherein the open end portion 30 was about 10.8 mm, the middle portion 29 was about 27.7 mm, and the closed end portion 28 was about 10.3 mm. The open end and middle portions had an inner diameter of about 3.90 and 3.60 mm, respectively, with a variable wall thickness as shown in FIG. 2. The closed end portion 28 had an inner diameter of about 3.20 mm. A constant wall thickness of 0.85 mm was maintained from a tip of the closed end portion 28 toward the middle portion 29 for an axial length of about 10.0 mm.

Electrolyte 26 can be any material that is capable of permitting the electrochemical transfer of oxygen ions while inhibiting the physical passage of exhaust gases, that preferably possesses an ionic/total conductivity ratio of approximately unity, and that is compatible with the environment in which the sensor will be utilized (e.g., temperatures up to about 1,000° C.). Possible solid electrolyte materials include metal oxides such as zirconia, alumina, and the like which may optimally be stabilized with yttria, calcia, magnesium, calcium, yttrium, aluminum, lanthanum, cesium, silica, gadolinium, among other materials and oxides thereof, and combinations comprising at least one of the foregoing electrolyte materials. For example, the solid electrolyte material can be yttria-stabilized zirconia, with a concentration of about 2 to about 14 weight percent (wt. %) yttria preferred, and a concentration of about 3 to about 12 wt. % yttria most preferred, based upon the total weight of the electrolyte 26.

The cylindrically shaped electrolyte 26 can be formed using techniques such as injection molding, isostatic pressing and grinding, die pressing, roll compaction, sintering, extrusion, sputtering, chemical vapor deposition, screen printing, stenciling, combinations comprising at least one of the foregoing techniques, and the like. Preferably, the cylindrically shaped electrolyte 26 is fabricated by injection molding.

Disposed on opposite sides of electrolyte 26 are electrodes 32, 34. Electrodes 32, 34 can comprise any catalyst capable of ionizing oxygen, including, but not limited to, catalysts such as gold, platinum, palladium, rhodium, ruthenium, osmium, iridium, zirconium, yttrium, cerium, calcium, aluminum, and the like, alloys, metal oxides, and combinations comprising at least one of the foregoing catalyst materials. In a preferred embodiment, the electrode comprises platinum.

Typically, the thickness of electrodes 32, 34 is effective to provide a current output sufficient to enable reasonable signal resolution over a wide range of air/fuel ratios. The electrodes 32, 34 generally possess porosities sufficient to permit the diffusion of oxygen and exhaust gas molecules therethrough and thicknesses sufficient to attain the desired catalytic activity. It is a general rule that porosity should be sufficiently great as not to substantially restrict gas diffusion. Generally, a thickness of about 1.0 to about 25 micrometers can be employed, with a thickness of about 5 to about 20 micrometers preferred, and about 10 to about 18 micrometers more preferred. The geometry of the electrodes 32, 34 is generally conical, i.e., conforms to the geometry of the electrolyte 26.

For placement in an exhaust gas stream, oxygen sensor 10 is preferably disposed within a protective casing having holes, slits or apertures, generally to limit the overall exhaust gas flow contacting sensor element 10 and prevent damage from contact with particles and/or condensation. This arrangement can be used to extend the useful life of oxygen sensor 10 by minimizing the ion transport through the electrodes and electrolyte.

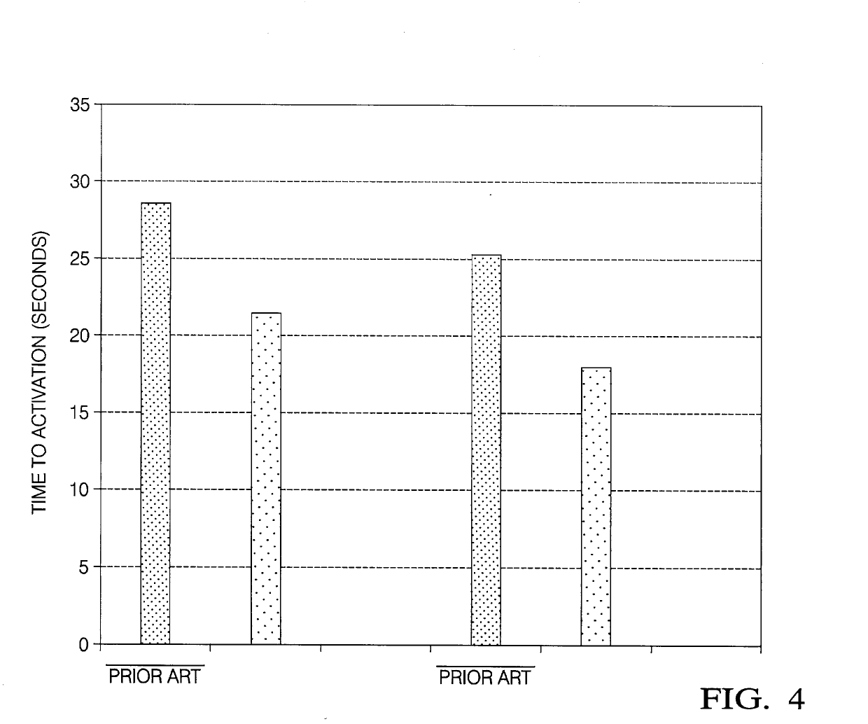

FIG. 4 graphically illustrates the time for activation for oxygen sensors constructed in accordance with the present disclosure compared to prior art oxygen sensors. The oxygen sensors were provided and tested with standard protective casings and operating voltages, e.g., 7.5 and 8.5 watts. The standard protective casing is of a double shield design, wherein each shield includes a plurality of offset perforations relative to the other shield. In comparison to the prior art sensors, the oxygen sensors constructed in accordance with the present disclosure provided at least about a 6 second improvement in the time for the oxygen sensor to become activated (e.g., the present oxygen sensors activate in less than or equal to about 21 seconds or less depending on the operating parameters).

The oxygen sensor described herein improves the detection and measurement of oxygen concentrations and partial pressures, in several advantageous ways. The closed end portion 28 has a relatively thin wall structure and as such, a low mass. The low mass and uniform thickness equal to or less than about 1.5 mm in the axial closed end portion 28 provides greater and more uniform thermal conductivity resulting in a faster time to activation compared to prior art sensors. As a result, the oxygen sensor provides a faster time to reach activation temperature.

Also, the oxygen sensor described herein having the electrolyte layer also provides a closer relationship between the heater and the lower portion (i.e., closed end portion 28). This further reduces the time to activation. In FIG. 4, the light-off times were reduced by at least about 6 seconds, as compared to prior art sensors operating under the same conditions.

While preferred embodiments have been shown and described, various modifications and substitutions may be made thereto without departing from the spirit and scope of the invention. Accordingly, it is to be understood that the fuel reformer has been described by way of illustration only, and such illustrations and embodiments as have been disclosed herein are not to be construed as limiting to the claims.

1. A gas sensor, comprising:
a first electrode and a second electrode; and
an electrolyte disposed between the first electrode and the second electrode, wherein the electrolyte is cylindrically shaped with an axial open end portion and an axial closed end portion, wherein the closed end portion has a uniform wall thickness equal to or less than about 1.5 millimeters.

2. The gas sensor according to claim 1, wherein the wall thickness of the closed end portion is less than or equal to about 1.0 millimeters.

3. The gas sensor according to claim 1, wherein the uniform wall thickness of the axial closed end portion is less than or equal to about 0.5 millimeters.

4. The gas sensor according to claim 1, wherein the electrolyte further comprises an axial middle portion having an inner diameter D2, wherein the axial open end portion has an inner diameter D1 and the axial closed end portion has an inner diameter D3, and wherein D1 is greater than D2 and D2 is greater than D3.

5. The gas sensor according to claim 4, wherein the electrolyte further comprises a first shoulder formed in an interior surface of the cylindrically shaped electrolyte between the axial open end portion and the axial middle portion, and a second shoulder formed in the interior surface between the axial middle portion and the axial closed end portion.

6. The gas sensor according to claim 4, wherein the middle portion of the electrolyte has a wall thickness that decreases in a direction toward closed end portion.

7. The gas sensor according to claim 1, further comprising a ceramic rod heater including a heating zone disposed in the closed end portion, wherein the length of the closed end portion corresponds with a length of the heater zone on the ceramic rod heater, and wherein the ceramic rod heater comprises an outer diameter about equal to inner diameter D3 of the closed end portion.

8. A gas sensor, comprising:
a first electrode and a second electrode; and
an electrolyte disposed between the first electrode and the second electrode, wherein the electrolyte is cylindrically shaped with an axial open end portion having an inner diameter D1, an axial middle portion having an inner diameter D2, and an axial closed end portion having an inner diameter D3, wherein D1 is greater than D2 and D2 is greater than D3.

9. The gas sensor according to claim 8, wherein a radial transition between the middle and the closed end portions forms a shoulder.

10. The gas sensor according to claim 8, wherein the closed end portion has a uniform wall thickness less than or equal to about 1.5 millimeters.

11. The gas sensor according to claim 8, wherein the closed end portion has a uniform wall thickness less than or equal to about 1.0 millimeters.

12. The gas sensor according to claim 8, wherein the closed end portion has a uniform wall thickness less than or equal to about 0.5 millimeters.

13 A process of sensing exhaust gas, comprising:
disposing a gas sensor in an exhaust stream, the gas sensor comprising a sensing electrode, a reference electrode, and an electrolyte disposed between the sensing electrode and the reference electrode, wherein the electrolyte is shaped into a cylinder with an axial open end portion and an axial closed end portion, wherein the axial closed end portion has a uniform wall thickness equal to or less than about 1.5 millimeters of the closed end portion;
contacting the closed end portion of the sensor with the exhaust gas; and
creating an electromotive force.
